(19) United States
(12) Patent Application Publication
(10) Pub. No.: US 2005/0177830 A1
(43) Pub. Date: Aug. 11, 2005

(54) Computational processing

(76) Inventor: Richard M. Troy III, Oakland, CA (US)

Correspondence Address: RICHARD M. TROY, III, 4200 PARK BOULEVARD, BOX 151, OAKLAND, CA, 94602, US

(21) Appl. No.: 10/713,669

(22) Filed: Nov. 17, 2003

Related U.S. Application Data
(60) Provisional application No. 60/427,049, filed on Nov. 18, 2002.

(51) Int. Cl. G06F 9/46

(52) U.S. Cl. 718/100

(57) ABSTRACT

This invention may be understood as follows: Unlike existing processing schemes, this invention describes a strategy by which archetypal meta-data describes processes, not just pointers to executable code, are used to instantiate running processes. This meta-data describes available processes, their parameters and their results and is stored in a database. This meta-data includes a reference to the data-type of each parameter and result. The meta-data also describes how each process is to be executed (initiated) conforming to the needs of an execution engine. The needs of the execution engine are unimportant regarding this invention; what is important is that the meta-data describes how to instantiate a running instance of processes so described in sufficient detail to permit execution to occur using that particular execution engine in a machine automateable fashion.

### BACKGROUND

This invention is focused upon the use of computers to process data. The invention herein described is an innovation to the process by which computers may perform discrete processing steps. Implementations of this invention may be either integrated with or layered on top of a computer operating system as the invention itself is not concerned so much with the details of computer hardware as with the process (procedure or method) by which a computer may execute work.

While there are surely a large number of strategies for performing “Computational Processing”, existing technologies which constitute prior art consists of computer operating systems because this is a general-purpose, not highly tailored, technology. This invention distinguishes itself from existing technologies in several important respects, as described below.

### SUMMARY

In all cases when digital computers are used to perform Computational Processing, data is brought in, processed by a program, and results are returned. The program directs hardware elements to perform steps which implement an algorithm that operates upon the data and creates results. Both the inputs to and results from the program are data, descriptions of the program, inputs and results are meta-data, and the method by which the effort is organized and executed is Computational Processing. This invention provides a superior method by which Computational Processing may be achieved. What distinguishes it from other Computational Processing paradigms is the explicit management and use of meta-data.

The most common Computational Processing systems are a group known as operating systems. Operating Systems are, by definition, general purpose, and they offer application programs that they run an unlimited or unspecified capability to take in inputs and create outputs but offer no or very limited capacity to manage the meta-data surrounding the activity; each program knows what it needs and that's considered sufficient. The advantage of this invention over existing operating systems is the explicit availability of meta-data to both people and computational elements that oversee the performance of Computational Processing. This invention provides a more flexible and more capable processing strategy by virtue of the utility of the descriptive nature of the meta-data known about given processes, their inputs, and their results.

### DESCRIPTION

Because of the wide variety of vocabulary in common use for describing these elements, for purposes of describing this invention, the following definitions, while not exhaustive, may aid clarity. To wit:
“Process” refers to the desired processing, also known as an algorithm, function, or program.
“Parameter” describes data which is input for processing, also known as an argument. (A Parameter may be null.)
“Result” describes data which is output from processing. (Like Parameters, Results may also be “null”, the empty set.)
For purposes of describing this invention, a “Database” is a repository of data (which may constitute information) along with access tools or methodology by which the data may be stored and retrieved. A database may be as sophisticated as a Relational Database Management System (RDBMS) such as Oracle, Informix, DB2, Postgres and the like, or it may be as simple as an in-memory listing; the form the database takes is not important for the purposes of this invention, only that the database is accessible to elements beyond a single running program.
An “Execution Engine” is a component which runs throughout the time period that the “Computational Processing” system described herein is operational. Its purpose is to provide computationally performed decision making in which the choice to run any particular process is made. It may be integrated within an operating system (O/S) (often known as a scheduler), or it may be a separate from the O/S, viewed as a user-level activity by the O/S (often known as a daemon).
“Meta-data” is data which describes other data. For example, if you were a datum, your name and hair-color would be some of the meta-data that describes you.
“Archetype”, in this context, refers to a description of a process, as distinguished from a running instance of the process. The Archetype includes a basic description of a process, its input parameters, its output results and so on. The archetype is a description of what a process is like but does not represent any particular running example of the process.
“Instance” refers to a specific instance of a process described by an archetype while “Instantiation” is the act of creating that running instance. Instances, therefore, have specific parameter values associated with them, for example.

Given the above definitions, the Computational Processing invention may be understood as follows: A set of meta-data describes available processes, their parameters and their results and is stored in a database. This meta-data includes a reference to the data-type of each parameter and result. Because a result from one process may be used as an input to another process, a potential connection is thereby described. The meta-data also describes how each process is to be executed (initiated) conforming to the needs of an execution engine. The needs of the execution engine are unimportant regarding this invention; what is important is that the meta-data describes how to instantiate a running instance of processes so described in sufficient detail to permit execution to occur using that particular execution engine in a machine automateable fashion.

Collectively, one key aspect of the utility of the meta-data is to provide information which is useful for linking together processes. Other components in an environment may use the meta-data to develop and instantiate a processing chain that is not otherwise possible without the discrete information provided by this innovation.

This invention has similarities with conventional computer operating systems but what sets it apart from them is the use of meta-data. In other systems many “assumptions” are made and a specification is developed which eliminates the need for a separate meta-data database. On occasion some extra data is provided for, such as user account information, however it must be noted that the use of such information is not involved in the actual process-scheduling mechanism.

There are two “best” strategies for implementing this invention. [symbol] One very elegant way would be to integrate these features into an existing computer operating system. The most significant work would be to update or rewrite the O/S's scheduler to become the Execution Engine described above, taking advantage of the meta-data. General purpose operating systems inherently include a process-queue mechanism by which waiting and running jobs are managed and this queue and related tools would be utilized in the implementation incorporating this invention as well.

[symbol] Instead of modifying an existing operating system, this invention may be implemented readily enough “on top of” a standard, commercial operating system such as Red Hat's Linux, Microsoft's Windows, or even Apple's Macintosh MacOS (and OSX), with the execution engine implemented as a separate process which itself is instantiated and managed by the underlying operating system. In this case, the database schema may be extended to take on the role of managing the process queue such that new job entries placed into the database's queue are then noticed by the execution engine and instantiated in the underlying operating systems existing processing machinery.

1. I claim as my invention a novel method by which computer programs are run:
a meta-data database provides for information regarding each process' archetype (specifically including a description of each process, how to run it, its input arguments/parameters, if any, and their types, its results, if any, and their types);
a “process queue”, which also resides in a database, provides for pointers to which processes are desired to be run, the run-time values for the arguments/parameters described in the meta-data, and;
an “execution engine” (sometimes known as a “scheduler” or “daemon”) uses this archetypal and process queue data to manage the creation of running instances within the operating system.
